(19) United States
(12) Patent Application Publication
(10) Pub. No.: US 2005/0232271 A1
(43) Pub. Date: Oct. 20, 2005

(54) Transmission of services in a wireless communications network

(75) Inventors: Kimmo Kettunen, Espoo (FI); Juho Pirskanen, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/894,239

(22) Filed: Jul. 20, 2004

(30) Foreign Application Priority Data
Apr. 15, 2004 (GB) 0408423.2

(51) Int. Cl. H04L 12/56

(52) U.S. Cl. 370/390

(57) ABSTRACT

A method of communicating a service from a network entity to a user in a wireless communications network, the method including scheduling transmission of a sequence of logical units delivering the service in a first logical layer, including scheduling periods of interrupted transmission in which no units are transmitted. The method also includes converting the logical units to transmission units for transmission in a physical layer and inserting, into at least one of the logical units at the logical layer, an indicator of the start of a period of interrupted transmission. The method further includes, at the user, receiving transmission units over the physical layer, reassembling logical units therefrom, and detecting the start of the period of interrupted transmission based on the indicator.

The present invention relates to the transmission of services in a wireless communications network, and particularly but not exclusively to the transmission of multimedia broadcast multicast services (MBMS).

The transmission of MBMS services is known in wireless communications networks. Such services allow user equipment (UE) such as mobile telephones or other mobile terminals to receive services from service providers via the network. The services are generally delivered in a packetised format, currently in the form of IP (Internet protocol) packets. In MBMS, the transmission of a particular service may be periodically suspended (that is, there is a period of discontinuous transmission, DRX). The service is provided by a service provider to a radio network controller which controls how the service is delivered to mobile terminals within the network. The radio network controller schedules the transmissions of services according to network resources and other factors. Therefore, the radio network controller has control of the scheduling and can determine when a particular service is to be periodically suspended, either to provide the resource which is currently carrying that service for some other purpose, or due to lack of incoming data packets.

It would be desirable to indicate to a user that these breaks in service transmission were about to occur, so that the user could either save power by switching off reception or, more importantly, perform other tasks such as inter-frequency/inter-RAT (radio access technology) measurements.

According to one aspect of the present invention there is provided a method of communicating a service from a network entity to a user in a wireless communications network, the method comprising: scheduling transmission of a sequence of logical units delivering the service in a first logical layer, including scheduling periods of interrupted transmission in which no units are transmitted; converting said logical units to transmission units for transmission in a physical layer; inserting into at least one of said logical units at the logical layer an indicator of the start of a period of interrupted transmission; at the user, receiving transmission units over the physical layer and reassembling logical units therefrom; and detecting the start of the period of interrupted transmission based on said indicator.

Another aspect of the invention provides a network entity for use in a wireless communications network, the network entity comprising: means for scheduling transmission of a sequence of logical units delivering a service in a logical layer, including scheduling periods of interrupted transmission in which no units are transmitted; means for converting said logical units to transmission units for transmission in a physical layer to a user in the wireless communications network; and means for inserting into at least one of said logical units at the first logical layer an indicator of the start of a period of interrupted transmission.

A further aspect of the invention provides a mobile terminal for use in a wireless communications network, the mobile terminal comprising: means for receiving a stream of transmission units representing a service; means for reassembling logical units from the transmission units; means for detecting an indicator in at least one of said logical units, the indicator denoting the start of a period of interrupted transmission; and means for discontinuing reception services on detection of the start of the period of interrupted transmission based on said indicator.

In the preferred embodiment, not only is the start of the period of interrupted transmission indicated, but also its duration. This is done by including a value relating to the duration of the interrupted transmission period in at least one of said logical units.

In the described embodiment, the logical layer is implemented in the radio link control (RLC) protocol layer for each service in a UTRAN (Universal Telecommunications Radio Access Network) network. This is particularly useful, because in a situation where a service is delivered as two streams of transmission units that are identical versions of each other and that represent the same service for multiple cells, there is a separate RLC protocol entity for each service. According to the described embodiment, information is included in the RLC protocol description unit (PDU) to indicate when the next forthcoming break in the transmission of the particular service is going to take place.

The indicator can be a flag in the last PDU before the DRX period or break. Alternatively or additionally, a time value can be inserted into one or more earlier PDUs before the break so that the break can be anticipated at the receiving mobile terminal.

In the described embodiment, the indicator is included in the header of a PDU. However, it will readily be appreciated that the indicator or indicators could be included in any suitable place in the PDU, for example in a padding field.

The multimedia broadcast multicast service is defined in 3GPP for Rel 6. The standard TS22.146 defines the high level service requirements of the MBMS, and the 3GPP standard TS22.246 defines typical service scenarios. TS22.146 defines that the MBMS consists of two modes, broadcast mode and multicast mode. A multicast mode consists of both point-to-point (p-t-p) and point-to-multipoint (p-t-m) transmission options over the air interface. In the following description, the embodiment of the invention is described in the context of p-t-m multicast mode, but it will be appreciated that the invention can be implemented in broadcast mode, p-t-p transmission mode of multicast mode or even normal p-t-p transmission of user equipment dedicated services.

For a better understanding of the present invention and to show how the same may be carried into effect, reference will now be made by way of example to the accompanying drawings, in which:

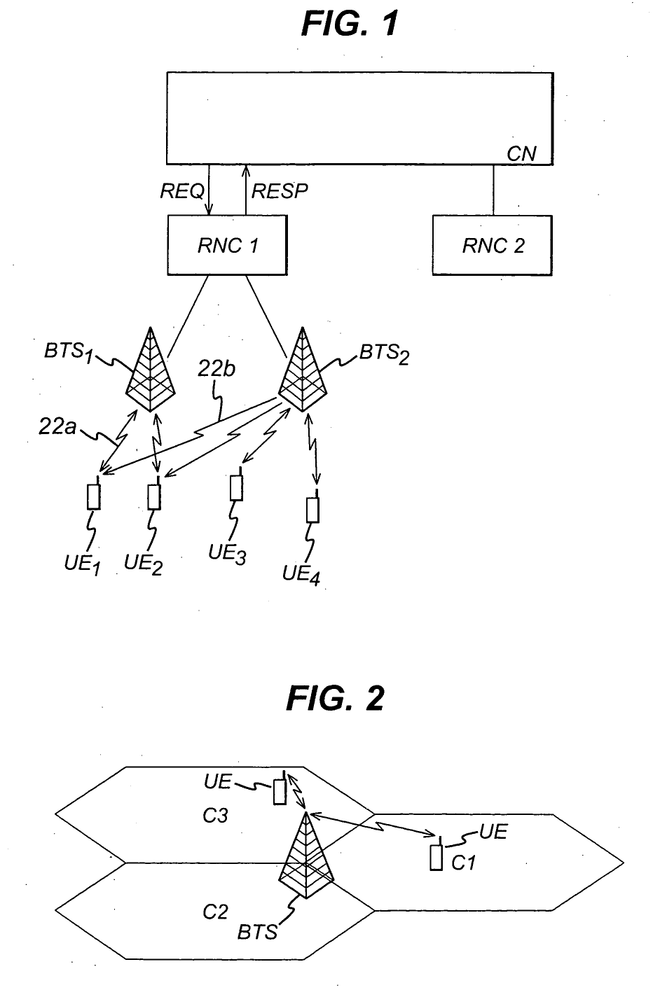

FIG. 1 is a schematic block diagram of the architecture of a communications network;

FIG. 2 is a schematic diagram illustrating the cellular structure of the network;

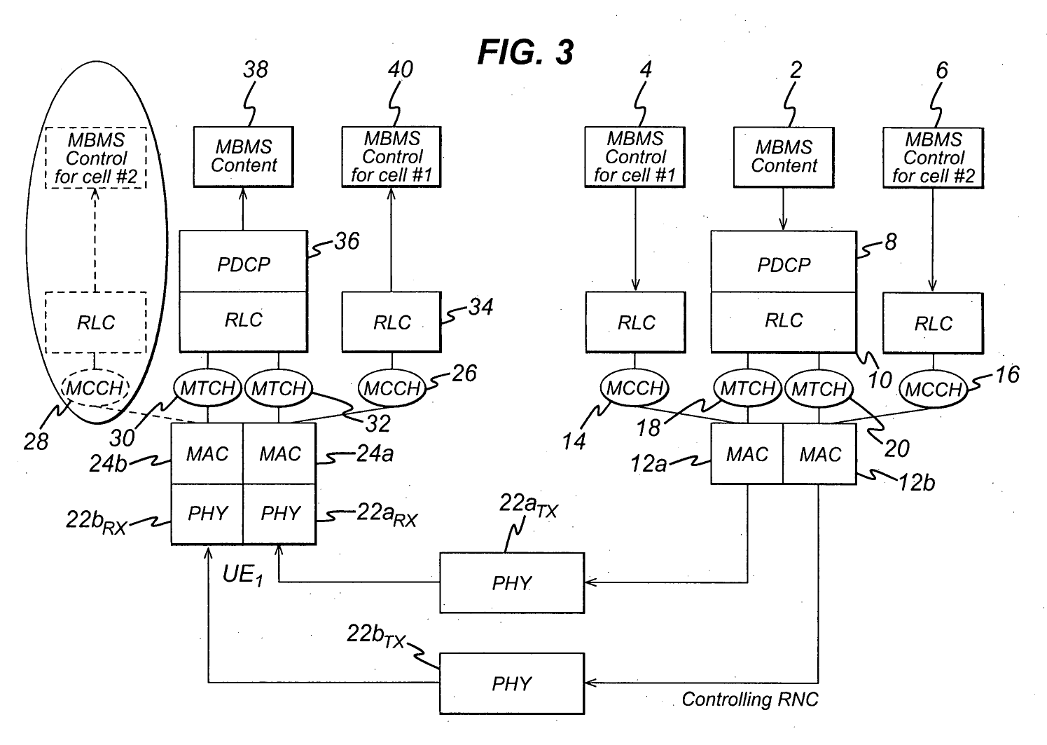

FIG. 3 is an architecture diagram illustrating the protocol architecture for implementation of one embodiment of the invention;

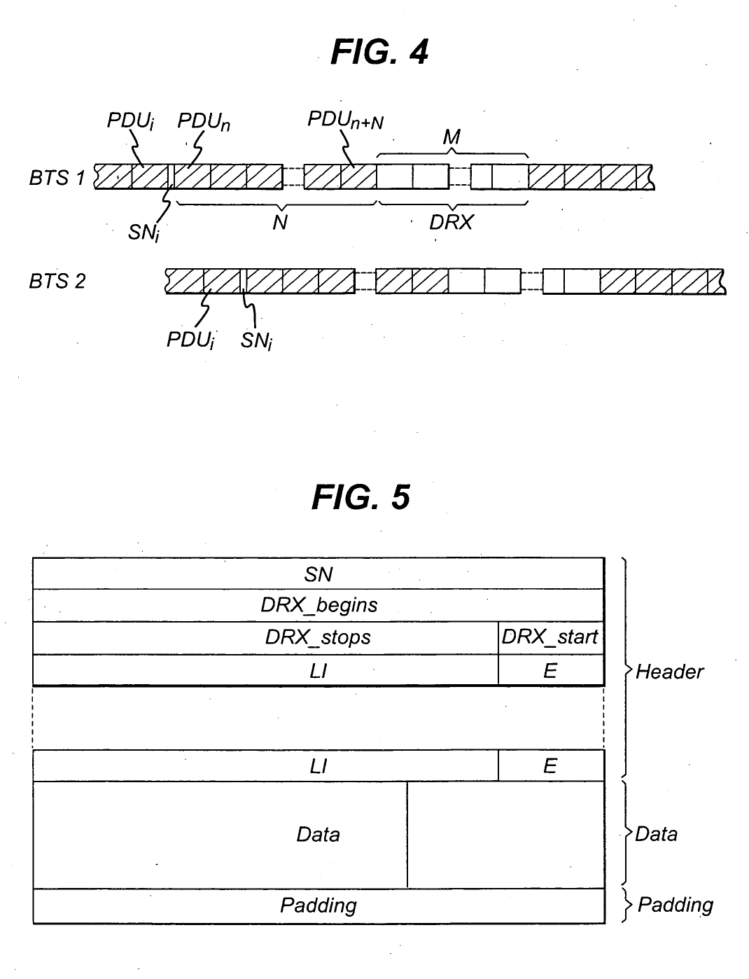

FIG. 4 illustrates the data streams for serial combining in MBMS;

FIG. 5 is a schematic diagram of a PDU;

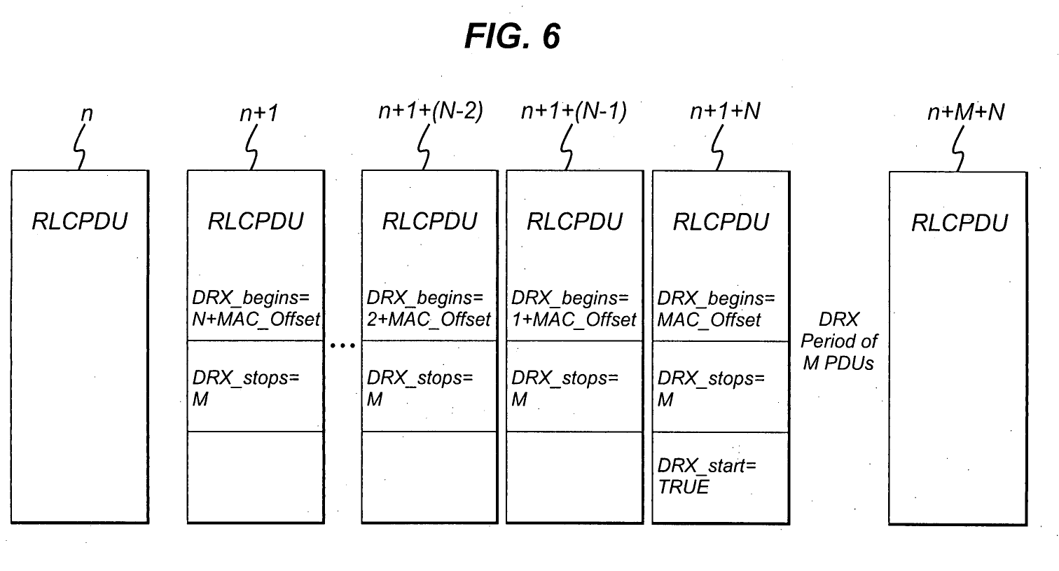

FIG. 6 is a schematic diagram illustrating indicators in PDUs for indicating transmission breaks; and

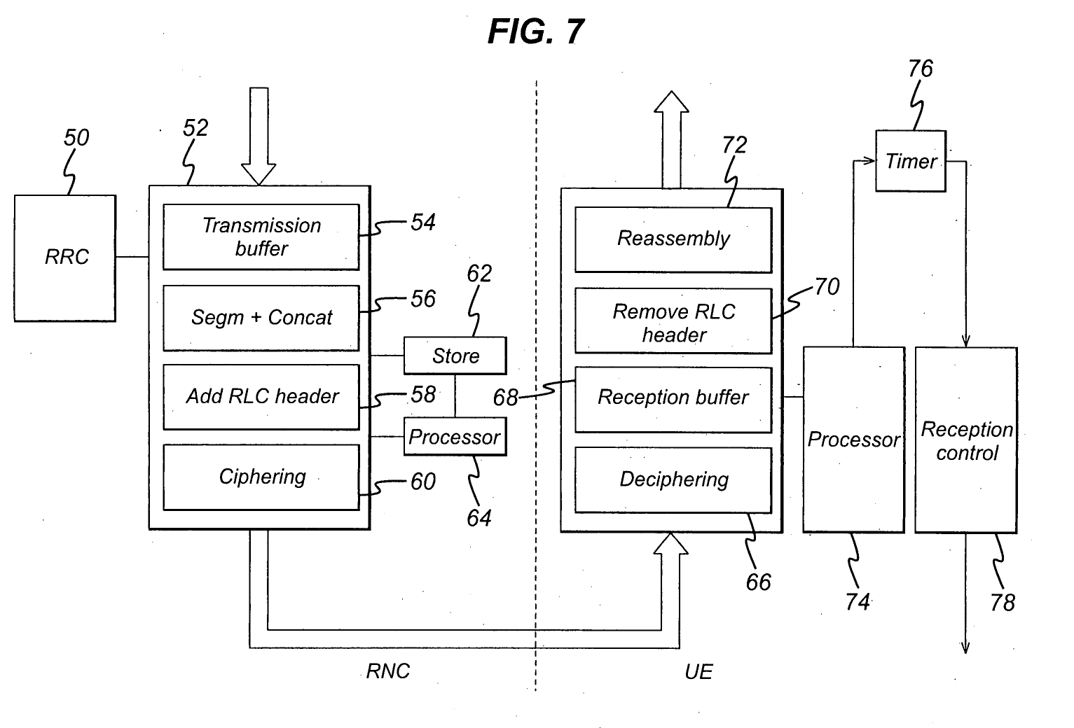

FIG. 7 is a schematic block diagram of transmitting and receiving entities.

FIG. 1 is a schematic diagram illustrating the important parts of the architecture of a cellular communications network for implementing multimedia broadcast multicast service (MBMS). A core network (CN) communicates with a plurality of radio network controllers, two of which RNC1 and RNC2 are illustrated in FIG. 1. Each radio network controller manages a set of base stations (or node B in the terminology of a UTRAN (Universal Mobile Telecommunications Radio Access Network)) which are labelled herein BTS1, BTS2 respectively. The base stations are in communication with a plurality of mobile terminals which are referred to herein as user equipment UE. Four such mobile terminals are shown in FIG. 1 labelled UE1, UE2, UE3, UE4. The mobile terminals UE1, UE2 are shown in communication via physical signalling links with the base stations BTS1, BTS2. The mobile terminals UE3, UE4 are shown in communication only with the second base station BTS2.

FIG. 2 is a schematic diagram showing part of the layout of the cellular communications network. In particular, three hexagonal cells C1, C2, C3 are shown under the control of a single base station BTS. It will readily be appreciated that the radio network controller can manage a number of cells via a single base station BTS, in addition to or instead of managing a plurality of base stations. Therefore, in the following, cell transmissions will be used to refer to individual physical links within cells, whether or not these come from a single site or a plurality of sites.

Assume for the purposes of the following discussion that the mobile terminals UE1, UE2 are receiving a multimedia broadcast multicast service which is being delivered to them by the base stations BTS1, BTS2.

As is known, the MBMS service consists of a broadcast mode and a multicast mode. In a broadcast mode, all mobile terminals in a particular cell can receive the service which has been broadcast from the base station of that cell. The broadcast mode does not require any subscription as well as activation/joining with the cellular network by the mobile user for receiving this service as no charge is applied by an operator. In contrast, the multicast mode requires subscription to receive the service as there is charging associated with it. A mobile user has to activate/join the multicast service for receiving the MBMS service and has to be able to deactivate/leave the multicast service at any time. The multicast mode covers point-to-point transmission and point-to-multipoint transmissions. As an example, the service being delivered by the second base station BTS2 to the mobile terminal UE3 only would be considered as a point-to-point (p-t-p) transmission. The service which is being delivered by the first base station BTS1 to the mobile terminals UE1, UE2 is a point-to-multipoint (p-t-m) transmission. Note also that the p-t-m service being delivered to mobile terminals UE1, UE2 is being delivered from the second base station as well, in a technique known as “selective combining”, which is discussed in greater detail in 3GPP TS25.346. Selective combining increases the transmission capacity of the MBMS point-to-multipoint transmission in the multicast and broadcast modes. The embodiments of the invention discussed in the following are discussed in the context of point-to-multipoint multicast mode, but are applicable for point-to-point mode and broadcast mode.

In order to establish an MBMS service, the core network CN transmits an MBMS context establishment request labelled REQ in FIG. 1 to the radio network controller RNC1 (for example) and the radio network controller RNC1 returns an MBMS context establishment response labelled RESP in FIG. 1. The request includes the necessary MBMS parameters, e.g. QoS. It is the responsibility of the radio network controller RNC1 to establish the MBMS context within the RNC for the respective MBMS service. The RNC may establish the MBMS data bearer with the CN before the notification phase or after the notification phase. The RNC determines how the MBMS service will be supplied across the network, and in particular whether it will be delivered from a single cell or multiple cells (as shown in FIG. 1 for the service which is being delivered to the mobile terminals UE1, UE2).

FIG. 3 is a schematic diagram illustrating the protocol architecture for delivering an MBMS service using selective combining. As is well known, the protocol stack according to 3GPP comprises a plurality of layers, beginning at the physical layer PHY which represents the signalling link, then a medium access control (MAC) protocol layer, then a radio link control (RLC) protocol layer and then a packet data convergence protocol (PDCP) layer. The 3GPP protocol stack includes a number of other layers, but only these are pertinent to the delivery of MBMS services.

FIG. 3 illustrates on the right hand side the application of these layers in the controlling RNC1. That is, the RNC receives MBMS content 2 together with MBMS control signals 4, 6 for cell 1 and for cell 2. It is assumed herein that the base station BTS1 controls cell 1 and the base station BTS2 controls cell 2, noting that this is the architecture of FIG. 1, and not of FIG. 2. The MBMS content 2 is processed in the packet data convergence protocol layer PDCP 8. Then, the packetised data is delivered to a data plane of the RLC layer 10, while the control signals 4, 6 are delivered respectively to a control plane of the RLC layer 10. At the RLC layer, RLC PDUs (protocol description units) are constructed as discussed in more detail later. To support MBMS data and control, the MAC layer 12 provides MBMS (KKe: MBMS, not MAC) control channels MCCH 14, 16 and MBMS traffic channels MTCH 18, 20 for each base station which will deliver the service. That is, the splitting up of the MBMS service is effected in the MAC layer by using two separate MBMS traffic channels 18, 20 and thus effectively dividing the MAC layer 12 into two MAC entities 12a, 12b. Each MAC entity 12a, 12b communicates with a respective physical layer 22a, 22b for providing transmission units delivering the MBMS service to the mobile terminal, for example UE1. The left hand side of FIG. 2 illustrates the equivalent protocol layers at the mobile terminal UE1. In this context, it can be considered that 22a_{TX} represents the transmission side of the physical link between the base station BTS1 and mobile terminal UE1, while 22a_{RX} represents the received side of the physical channels respectively at the mobile terminal UE1. The mobile terminal UE1 implements MAC entities 24a, 24b and provides similar MBMS control channels and MBMS traffic channels 26, 28, 30, 32 as for the controlling RNC1. The RLC layer deals with combining the packets which have been delivered by the separate MAC entities and also separates out the control functionality. Selective combining in MBMS is only possible for MBMS user data i.e. data transmitted via MTCH. Selective combining is not possible for MBMS control data transmitted via MCCH, which can differ between different cells. Finally, the PDCP layer delivers the MBMS content to the user. The control channel and control signalling for cell 2 is shown dotted and in a circle in FIG. 3, because it is not always necessary to provide this.

Thus, it can be seen that the mobile terminal processes the transmission units received from the multiple cells both at the physical layer 22a, 22b and at the MAC layer 24a, 24b independently from each other, while the selective combining is done at the RLC layer. The main advantage of this is that the synchronisation requirement is looser due to greater buffering capability at the RLC layer in the mobile terminal.

FIG. 4 illustrates the principle of MBMS transmission, and selective combining. FIG. 4 shows a sequence of PDUs as delivered from each base station under the control of the controlling RNC1. Note that the PDUs are logical units which are delivered over the physical layer as transmission units such as blocks for frames. The data stream for the first base station is shown above the data stream for the second base station. The data stream comprises a plurality of PDUs, the ith one of which is denoted PDUᵢ. Shaded blocks denote PDUs which are transmitted, and non-shaded blocks denote that there is a gap in the transmission of the service for a length of time equal to a PDU transmission time. This downtime of discontinuous transmission is referred to herein as the DRX period.

Each PDU is identified by a sequence number SN which represents the location of that PDU within the sequence. The MBMS service is reconstructed at the user equipment UE based on receipt of the PDUs in order of their sequence numbers. In selective combining, the same sequence of PDUs is transmitted from two base stations (in this case BTS1, BTS2) to a single user equipment. This allows for the possibility of some PDUs to be dropped on a particular transmission channel but received on the other transmission channel. The user equipment UE looks at each PDU as it is received. If it has already received a PDU with the same sequence number, it uses the PDU that has the better quality, or selects the PDU on some other basis. Of course, if it only receives a PDU via one of the transmission channels, this is the one that it uses for that particular serial number. In accordance with an embodiment of the present invention, the beginning of the discontinuous transmission period is indicated to the user equipment UE prior to its commencement so that the UE can take steps to cut off its reception capability so that its resources can be used elsewhere. Consider that this indication is first given in the nth PDU, PDUₙ which is N PDUs prior to commencement of the DRX period. Consider also that the DRX period is M PDUs in length.

When transmitting from more than one base station, the effects of possible lack of synchronisation between the base stations need to be taken into account. Thus, a measurement is retained at the controlling RNC which represents the time difference between the earliest and latest BTS transmissions under the control of that RNC. Note that that can include base stations which are not involved in the delivery of any particular selectively combined MBMS service. This value is the MAC_offset value. In the case of FIG. 4, there is a difference between the base station BTS1 and base station BTS2 of two PDUs, which is why the transmission of BTS1 is shown later than the transmission of BTS2. However, the MAC_offset value for selectively combining in this situation can be greater than two PDUs because there might be other base stations under the control of the RNC.

An example of an RLC PDU in accordance with an embodiment of the invention is shown in FIG. 5. The PDU comprises a plurality of octets, a first group of which constitute a header, a second group of which constitute a data field and a third group of which constitute padding. Of importance, the sequence number (SN) field holds the unique sequence number for each PDU used for retransmission and reassembly. The header also includes one or more length indicator octets, L1, with possible extensions E, and three new information fields. These fields are:

DRX_begins: this is the remaining time before the start of the DRX period added to the MAC_offset value.

DRX_start: This is a Boolean value that is set true in the last RLC PDU before the beginning of the DRX period (PDU_{n+N} in FIG. 4).

DRX_stops: This is the length of the DRX period.

The above-referenced periods, DRX_begins and DRX_stops can be measured either as the number of PDUs, or in any other appropriate way. For example, the transmission time interval (TTI) which is used in the physical layer can be used as a measure of these periods, or alternatively the number of frames or blocks transmitted over the physical layer within each session. Any suitable measure of time, convertible to a digital value can be utilised. In the present embodiment, as illustrated in FIG. 4, the value for DRX_begins is measured as N PDUs, and the value DRX_stops is measured as M PDUs.

These information fields provide information to indicate when the next forthcoming break in the transmission of a particular service is going to take place. It will be clear therefore that it is not necessary for the new information fields to be present in all of the RLC PDUs which are transmitted, but only those which are associated with breaks in the transmission.

FIG. 6 shows a sequence of RLC PDU fields which illustrate how these fields are used. At a predefined time before the start of the DRX cycle (in this case N PDUs), the RNC starts to introduce into the RLC PDUs the DRX_begins and DRX_stops fields, beginning at the (n+I)th PDU. That is, FIG. 5 shows a first RLC PDUₙ which does not include these fields and then a subsequent RLC PDU field PDUₙ₊₁ which includes these fields. The value of the DRX_begins field is N+MAC_offset, and the value of the DRX_stops field is M. The value N denotes the predefined time, and this is decreased in subsequent PDUs by an amount equal to the time period of one PDU. The next PDU illustrated in FIG. 5 is the PDU (_{M+1(N-2)}) where the DRX_begins value is now 2+MAC_offset. The value of the DRX_begins field continues to decrease until, in the last RLC PDU which is transmitted before the beginning of the DRX period, that is RLC PDU (_{M+1+N}) the DRX_begins field equals the MAC_offset and the DRX_start field is indicated as true. There then follows a discontinuous transmission period of M PDUs, after which a new RLC PDU (_{N+M+N}) begins transmission.

The mobile terminal can stop the reception of the particular MBMS service when either the DRX_start field PDU is received, or the start time of the DRX period calculated from the previously received DRX_begins values is exceeded. The mobile terminal resumes the reception after the time indicated in the DRX_stop is passed from stopping the reception.

FIG. 7 illustrates a schematic block diagram of circuitry at the RNC and UE on the receive and transmit side respectively of an MBMS service. On the RNC side, a radio resource control unit RRC 50 controls operation of a transmitting RLC entity 52. The transmitting RLC entity 52 comprises a transmission buffer 54, a segmentation and concatenation unit 56, an Add RLC header unit 58 and a ciphering unit 60. The transmitting RLC entity also comprises a store 62 and a processor 64. At the user equipment UE, reception equipment comprises a receiving RLC entity which includes a deciphering unit 66, a reception buffer 68, a remove RLC header unit 70, a reassembly unit 72 and a processor 74. The UE circuitry also includes a timer 76, and a reception control unit 78 which is responsive to the timer.

At the RNC side, operation of the important components of the circuitry will now be described. The transmission buffer, segmentation and concatenation unit 56 and ciphering unit 60 are known in the art and are not germane to the present invention so they will not be described further herein. The RRC unit 50 holds information about the number N of PDUs which are to be measured prior to the start of a DRX period. The RRC unit 50 also controls the MAC_offset value. The RRC control unit 50 indicates to the transmitting RLC entity 52 the beginning and duration of the DRX period in the MBMS transmission, together with an indication as to when to start inserting the new information fields into the PDU. The new information fields are inserted at the Add RLC header block 58. The store 62 is used to store the values of MAC-offset, DRX_stops and in particular DRX_begins, which needs to be decremented after sending each PDU. The processor 64 calculates the value of the DRX_begin field and also when to insert the DRX_start field based on the number of PDUs which have been transmitted since commencement of introduction of the new information fields into the PDUs started. That is, in the preferred embodiment, the processor 64 calculates the DRX_begin field value and when this equals the MAC_offset value supplied from the RRC control unit 50, the DRX_start field is set to true to indicate commencement of the DRX period.

At the UE side, the processor 74 calculates the time to the commencement of the DRX period based on the value in the (N+1)th PDU and the DRX_begin field, read from the Remove RLC header block 70. This time is monitored by either actually calculating a time period which is supplied to the reception control unit 78 and monitored by the timer 76 or, as illustrated in FIG. 7, used to set a timer which then decrements by the appropriate duration up to the commencement of the DRX period. The processor 74 also calculates the DRX period and measures that in the same way.

The processor 74 also looks for the DRX_start indicator set to true and when it sees that it triggers the timer to end its timing period if it has not already ended it. In that way, if there has been some error in monitoring the period up to commencement of the DRX period, it is overwritten by the DRX_start indicator. The timer generates an output signal to the reception control unit 78 which causes the UE to turn off its reception capability at commencement of the DRX period. The DRX_stops field holds the length of the DRX period. The timer 76 is used to monitor this period and to turn the reception capability back on when it expires.

The above described embodiment of the invention is set in the context of an MBMS transmission using selective combining. The invention is particularly advantageous in that context, but it can be used in the more simple context where the MBMS service is delivered over a single physical channel from one base station to one or more mobile terminals. In that case, the MAC_offset value does not exist or alternatively is set to zero because there is no need to take into account the difference in synchronisation between a plurality of base stations.

Moreover, it will be appreciated that the commencement of the DRX period is indicated in the above embodiment in two different ways. The first way is by an indicator in the form of the DRX_start flag set to true in the PDU immediately prior to commencement of the DRX period. The second way is to “count down” to the start of the DRX period by setting a timing value as an indicator in a number of PDUs prior to commencement of the DRX period. By using these methods in combination, it is particularly certain that the mobile terminal will recognise commencement of the DRX period and properly stop its reception capability to save power. It will be appreciated however that either of these techniques could be used by themselves, the only disadvantage being that in some cases the mobile terminal will not always properly recognise commencement of a DRX period and will maintain power during that period. However, if only one of these techniques is used, it can be certain that for at least a good proportion of the time the mobile terminal will properly recognise commencement of the DRX period and be able to adjust its power requirements accordingly.

Moreover, it will be seen that in the preceding embodiment, the indicator in the form of a value for the time period remaining to commencement of the DRX period is included in each of a sequence of PDUs (in FIG. 5 from PDUₙ₊₁ to PDUₘ₊₁₊ₙ). However, once again if a less than perfect but still noticeable effect is to be achieved, the invention could be implemented with the indicator in only one of the preceding PDUs.

1. A method of communicating a service from a network entity to a user in a wireless communications network, the method comprising:
scheduling transmission of a sequence of logical units delivering a service in a first logical layer, including scheduling periods of interrupted transmission in which no units are transmitted;
converting said logical units to transmission units for transmission in a physical layer;
inserting into at least one of said logical units, at the first logical layer, an indicator of a start of a period of interrupted transmission;
at a user, receiving transmission units over the physical layer and reassembling the logical units therefrom; and
detecting the start of the period of interrupted transmission based on said indicator.

2. The method according to claim 1, wherein said indicator comprises a field which is set in one of said logical units to denote that said logical unit comprises a particular unit immediately preceding the start of the period of interrupted transmission.

3. The method according to claim 1, wherein said indicator comprises a value representing an amount of time remaining until the start of the period of interrupted transmission.

4. The method according to claim 3, wherein the amount of time remaining is expressed in terms of a number of logical units between said at least one of said logical units which includes the indicator and a unit immediately preceding the start of the period of interrupted transmission.

5. The method according to claim 3, wherein the amount of time remaining is represented as a value relating to a number of transmission units prior to commencement of the period of interrupted transmission.

6. The method according to claim 1, wherein said at least one of said logical units comprises a value indicating a length of the period of interrupted transmission.

7. The method according to claim 6, further comprising:
detecting an end of the period of interrupted transmission at a user.

8. The method according to claim 1, further comprising:
communicating the service over at least two transmission channels, wherein identical versions of the sequence of said logical units are delivered over the at least two transmission channels and wherein the identical versions are selectively combined at a user.

9. The method according to claim 8, further comprising:
utilizing a time offset between cells in which the identical versions are delivered to calculate a value representing a time remaining until the start of the period of interrupted transmission, wherein said indicator comprises the value.

10. The method according to claim 2, wherein at least one other unit of said logical units comprises a further indicator which represents a time remaining until the start of the period of interrupted transmission.

11. The method according to claim 1, wherein the first logical layer comprises a radio link control protocol layer of a 3GPP protocol stack.

12. The method according to claim 1 further comprising:
delivering the service in transmission units as frames over the physical layer.

13. The method according to claim 11, wherein the step of converting said logical units to said transmission units is carried out in a medium access control protocol layer.

14. The method according to claim 1, further comprising:
discontinuing reception services at the user when the start of the period of interrupted transmission is detected.

15. A network entity for use in a wireless communications network, the network entity comprising:
means for scheduling transmission of a sequence of logical units delivering a service in a logical layer, including scheduling periods of interrupted transmission during which no units are transmitted;
means for converting said logical units to transmission units for transmission in a physical layer to a user in a wireless communications network; and
means for inserting into at least one of said logical units at the first logical layer an indicator of a start of a period of interrupted transmission.

16. The network entity according to claim 15, wherein the network entity comprises a radio network controller.

17. The network entity according to claim 15, wherein the means for converting said logical units into said transmission units is configured to convert said sequence of said logical units into two streams of transmission units, each of the two streams representing said sequence.

18. The network entity according to claim 17, wherein said means for converting comprises first and second medium access control entities in a medium access control protocol layer.

19. A mobile terminal for use in a wireless communications network, the mobile terminal comprising:
means for receiving a stream of transmission units representing a service;
means for reassembling logical units from the transmission units;
means for detecting an indicator in at least one of said logical units, the indicator denoting a start of a period of interrupted transmission; and
means for discontinuing reception services upon detection of the start of the period of interrupted transmission, based on said indicator.

20. The mobile terminal according to claim 19, wherein said indicator comprises a value denoting a time remaining until the start of the period of interrupted transmission, and wherein the means for receiving includes receiving circuitry that includes a timer for monitoring said period and for indicating the start of the period upon completion of the period.

21. A mobile terminal, comprising:
receiving means for receiving transmission units over a physical layer and for reassembling logical units from the transmission units and
detecting means, operably connected to the receiving means, for detecting a start of a period of interrupted transmission based on an indicator.

22. A mobile terminal for use in a wireless communications network, the mobile terminal comprising:
a receiver configured to receive a stream of transmission units representing a service;
a processor configured to reassemble logical units from the transmission units;
a detector configured to detect an indicator in at least one of said logical units, the indicator denoting a start of a period of interrupted transmission; and
a controller configured to discontinue reception services upon detection of the start of the period of interrupted transmission, based on said indicator.

23. A mobile terminal, comprising:
a receiver configured to receive transmission units over a physical layer and configured to reassemble logical units from the transmission units; and
a detector configured to detect a start of a period of interrupted transmission based on an indicator.

24. A communications system, the system comprising:
a first controller configured to schedule transmission of a sequence of logical units delivering a service in a first logical layer, including scheduling periods of interrupted transmission in which no units are transmitted;
a first processor configured to convert said logical units to transmission units for transmission in a physical layer;
a second processor configured to insert into at least one of said logical units, at the first logical layer, an indicator of a start of a period of interrupted transmission;
a receiver configured to receive, at a user, transmission units over the physical layer and reassembling the logical units therefrom; and
a detector configured to detect the start of the period of interrupted transmission based on said indicator.
